(19) United States
(12) Patent Application Publication
(10) Pub. No.: US 2005/0044119 A1
(43) Pub. Date: Feb. 24, 2005

(54) Pseudo-random number generator

(76) Inventors: Jerry Joe Langin-Hooper, Colorado Springs, CO (US); Kanan Joseph Langin-Hooper, Colorado Springs, CO (US)

Correspondence Address: LINDA FLEWELLEN GOULD, 1665 BRIARGATE BLVD. #101, COLORADO SPRINGS, CO, 80920, US

(21) Appl. No.: 10/646,939

(22) Filed: Aug. 21, 2003

(51) Int. Cl. G06F 1/02

(52) U.S. Cl. 708/250

(57) ABSTRACT

The present invention provides a method and an apparatus for generating pseudo-random numbers with very long periods and very low predictability. A seed random sequence is extended into a much longer sequence by successive iterations of matrix operations. Matrices of candidate output values are multiplied by non-constant transition matrices and summed with non-constant offset matrices; the result is then processed through one or more modulus operations, including non-constant modulus operators, to generate the actual output values. The invention also includes the possibility of introducing non-invertible matrices into the operations. The invention creates final results that are equidistributed over large samples. Secondary pseudo-random and other processes determine the non-constant transition matrices, offset matrices, and modulus operators.

### BACKGROUND OF THE INVENTION

1. Field of the Invention

The present invention relates generally to a method of and apparatus for generating pseudo-random numbers.

2. Description of the Prior Art

Pseudo-random numbers are used for a variety of purposes including simulation studies, information processing, communication, and encryption. Pseudo-random number generators create sequences of values that appear to have been generated by random processes even though the sequences are not truly random. The results of a pseudo-random number process should be adequately distributed across the desired range of possible numbers so as to mimic the results that might have come from a truly random process. Pseudo-random results should not exhibit discernable patterns or other observable relationships between the observable output values that would make prediction or other analysis of the observable output sequence possible.

The search for pseudo-random number generators that satisfy the above conditions has yielded a number of interesting and useful processes. The linear feedback shift register (LFSR) process is easy to implement and has been widely used but has an inherent weakness due to the strict linearity of its processes. Another widely used generator is the classical linear congruential generator (LCG), represented as xₙ=(axₙ₋ₗ+b) mod m, where x is the output series, x₀ is the seed value, and a, b, and m are constants. For example, the LCG process is the framework used by DeVane in the high-speed pseudo-random number generator of U.S. Pat. No. 5,187,676, by Finkelstein in the encryption protection in a communication system of U.S. Pat. No. 6,014,446, by Tiedemann et al. in the system for testing a digital communication channel of U.S. Pat. No. 5,802,105, by Ridenour in the high precision pseudo-random number generator of U.S. Pat. No. 5,541,996, and by Shimada in the pseudo-random number generator of U.S. Pat. No. 6,097,815. LCG-based systems can generate well mixed numbers and will pass certain statistical tests, although the sequence generated by an LCG typically can be inferred even if the constant parameters a, b, m and the seed x₀ are all unknown.

The multiple recursive generator (MRG) is similar to an LCG but extends the range of the recursion from the immediately preceding output value to more distantly produced ones. The MRG process can be represented as xₙ₌₍ₐₗxₙ₋ₗ+ . . . +aₖxₙ₋ₖ) mod m, where aₗ . . . aₖ and m are constants. Lagged Fibonacci generators and some combined generators are essentially MRGs. The LCG process also has been extended to additional dimensions to create a matrix method (MM) process represented as Xₙ=(AXₙ₋ₗ) mod m where X is a vector of output values and A is a constant transition matrix. Niederreiter introduced the multiple-recursive matrix method (MRMM) as a framework for encompassing essentially all of the linear methods described above as well as several others such as the Generalized Feedback Shift Register (GFSR) and the “twisted” GFSR. A good example of the twisted GFSR is the recently developed Mersenne Twister described by Matsumoto and Nishimura. The general form of the MRMM process is Xₙ=(AₗXₙ₋ₗ+ . . . +AₖXₙ₋ₖ) mod m, where Aₗ . . . Aₖ and m are constants.

In these conventional systems, the modulus operator is typically chosen to be a fixed number, which may be determined by the hardware constraints of the computer systems to be used. Often, the word length is a critical factor; for instance, 2³² is typically chosen as the modulus value for 32-bit computer systems. Using a fixed modulus simplifies the determination of the output range of pseudo-random number generator. A fixed modulus of 2³², for example, creates a range of actual output values from 0 to 2³² −1. Others, such as Shimada, have suggested varying the modulus operator by using a set of prime numbers (see U.S. Pat. No. 6,097,815). Shimada uses a three-part expanded affine transformation to inflate the intermediate results of the variable modulus operation to the magnitude of the desired range, although only a portion of each resulting value is kept because the unaltered series is linear and therefore predictable in nature.

Many of the existing pseudo-random number generators are computationally efficient and generate well-distributed results. However, the recursive nature of the processes create output results that exhibit strong linear correlation; this structure tends to make those results exhibit characteristics which can be exploited to create predictions of future output values. Predictability of the series may not be a problem for some applications, but still indicates that the series is not as “random” for general applications as might be desired.

The invention described herein presents a general-purpose pseudo-random number generator that offers output sequences with very long periods and very low predictability.

### SUMMARY AND OBJECTS OF THE INVENTION

A primary object of the present invention is to provide a method and process for generating pseudo-random numbers with very long period output sequences, well-distributed actual output values, and very low predictability for general-purpose use. Another object of the present invention is to introduce variable recursive matrix operations into the pseudo-random number generator process where the transition matrices are changed from one iteration of the generator to the next. The variations in the transition matrices are determined by secondary pseudo-random number generators or other processes where the secondary pseudo-random number generators or other processes exhibit long cycles.

Another object of the present invention is to introduce variable recursive matrix operations into the pseudo-random number generator process where the offset matrices are changed from one iteration of the generator to the next. The variations in the offset matrices are determined by secondary pseudo-random number generators or other processes where the secondary pseudo-random number generators or other processes exhibit long cycles.

Another object of the present invention is to introduce variable recursive matrix operations into the pseudo-random number generator process where the modulus operators are changed from one iteration of the generator to the next. The variations in the modulus operators are determined by secondary pseudo-random number generators or other processes where the secondary pseudo-random number generators or other processes exhibit long cycles.

Another object of the present invention is to introduce a process for the use of multiple modulus operators where the results are equally distributed across the range of actual output values associated with the final modulus operator.

Another object of the present invention is to introduce the development of processes such that the output matrix can be created in such a way as to be non-invertible, that is, having no calculable inverse. The variable recursive matrix operations can be used to create output sets that cannot be inverted making it impossible to determine constituent components of the matrix operations simply from analysis of the observable output results.

These objects are achieved by introducing a new type of pseudo-random number generators that significantly extend the current state of the art. The multiple-recursive matrix method (MRMM) framework that encompassed essentially all prior linear methods is extended by this invention through the introduction of variable parameters. The class of pseudo-random generators of the invention can be denoted as multiple variable recursive matrix (MVRM) generators. As described in the following sections, the new class of MVRM pseudo-random number generators of this invention is well suited to general-purpose applications.

The need exists for pseudo-random number generators that offer results with more random-like characteristics. The precise definition of “more random-like” is difficult to specify, at best. This is especially true for pseudo-random number generators that are purely deterministic, that is, those which can replicate the same output results exactly given the same state of characteristics and input values for the generating process. Essentially all of the widely used linear methods described above are deterministic processes. The level of predictability is a reasonable indicator of the “randomness” of the pseudo-random number generator. While the methods and processes of the invention claimed herein are deterministic, the results are generally less predictable and more “random” than those of other types of pseudo-random number generators.

Computational efficiency has often been a key determinant in the design of pseudo-random number generators. However, computational power has increased dramatically over the past years, making possible the introduction of pseudo-random number generators that exchange reduced computational efficiency for increased “randomness”. The pseudo-random number generators of the claimed invention offer just such a compromise. Even so, depending on the specific implementation of the processes of the invention, the decrease in computational efficiency may be relatively slight while the gain in “randomness” may be substantial.

Pseudo-random number generators of the multiple-recursive matrix method (MRMM) take the general form of Xₙ=(AₗXₙ₋ₗ+ . . . +AₖXₙ₋ₖ) mod m, where Aₗ . . . Aₖ and m are constants and Xₙ₋ₗ . . . Xₙ₋ₖ are the previous results of the process. The multiple variable recursive matrix (MVRM) pseudo-random number generators of the claimed invention take the general form of Xₙ=((A_{l,n}Xₙ₋ₗ+ . . . +A_{k,n}Xₙ₋ₖ+B_{l,n}+ . . . +B_{j,n}) mod m_{l,n}) . . . mod m_{i,n}, where:
A_{l,n} . . . A_{k,n}, B_{l,n} . . . B_{j,n}, and m_{l,n} . . . m_{i,n} are variable transition, offset and modulus parameters for the n^{th} candidate output element of the matrix X,
the transition matrices A_{l,n} . . . A_{k,n} are created by secondary pseudo-random number generators or other processes,
the offset matrices B_{l,n} . . . B_{j,n} are created by secondary pseudo-random number generators or other processes, and
the modulus operators m_{l,n} . . . m_{i,n} are created by secondary pseudo-random number generators or other processes.

The form of the processes is unchanged if the transition matrices A_{l,n} . . . A_{k,n} are postmultiplied in the equation above instead of premultiplied as in the form shown.

In the MVRM process of the invention, the matrix of candidate output values Xₙ can be a matrix of any number of dimensions and sizes including columnar or row vector form. The matrix will have a number of elements determined by the number of rows times the number of columns. The specific entries from the total elements contained in the matrix Xₙ to be used as the pseudo-random number generator candidate output values could be single elements from specific locations of the matrix or all the values of the entire matrix. The dimensions of the candidate output matrix will determine the dimensions of the transition matrices and of the offset matrices. The transition matrices will be square matrices with row and column dimensions equal to the number of rows in the candidate output matrix. The offset matrices will have the same dimensions as the candidate output matrix.

The candidate output matrix Xₙ also can be created in such a way as to be non-invertible, that is, having no calculable inverse. This is a significant and distinguishing difference from the classic LCG pseudo-random number generators because the additive and multiplicative components of the LCG methods are always invertible, meaning that the LCG's observed output results are always invertible. Matrix and other similar data arrangements can be used to create output sets that cannot be inverted, making it impossible to determine constituent components of the matrix operations simply from analysis of the observed output results.

The multiple variable recursive matrix (MVRM) pseudo-random number generator process of the claimed invention has the form of Xₙ=((A_{l,n}Xₙ₋ₗ+ . . . +A_{k,n}Xₙ₋ₖ+B_{l,n}+ . . . +B_{j,n}) mod m_{l,n}) . . . mod m_{i,n}, that is, the n^{th} value of the candidate output matrix is created by summing the multiple of the n-l^{th} value of the candidate output matrix by the n^{th} value of the transition matrix Aₗ (either premultiplied or postmultiplied) with all subsequent multiples through the multiple of the n-k^{th} value of the candidate output matrix by the n^{th} value of the transition matrix Aₖ and the 1^{st} through the j^{th} values of the offset matrices Bₙ. The 1^{st} through the i^{th} modulus operators are sequentially applied to the resulting summation to yield the final n^{th} value of the candidate output matrix. The actual output pseudo-random numbers for that iteration of the generator are then taken from the candidate output matrix. In order to assure the uniformity of the distribution of the actual output values, certain results of the modulus operations may not be available for use as the pseudo-random number generator result; those intermediate results may or may not still be held in the historical sequence of candidate output matrix values Xₙ for the calculation of subsequent candidate output matrix values.

The variable transition matrices A_{l,n} . . . A_{k,n} are determined by secondary pseudo-random number generators or other processes. For instance, a simple list of 100 possible values for Aₗ could be compiled and the variation in the sequence of A_{l,n} as n goes from 1 to 100 would consist of selecting the next entry from the list. As the list is exhausted, the selection would return to the beginning of the list. Similar lists could be used for A₂ through Aₖ with each variation being chosen from the sequences in the lists. Advantageously, the number of items in the lists could be chosen to be relatively prime, that is, no count of items in any of the lists would share a common factor with another. The length of the composite sequence created by this combined sequence of lists would have a cycle length equal to the product of the number of items in each list. Thus, with k set equal to 4 and list lengths of 100, 101, 103 and 107, the length of the cycle of combinations would equal 111,312,100 before the pattern of combinations would begin to repeat. Instead of lists, each A_{l,n} . . . A_{k,n} could be determined by a secondary pseudo-random number generator with the cycle length of each pseudo-random number generator distinct from the others. The secondary pseudo-random number generators could be of virtually any form including the classical LCG or any of the variations mentioned above. With distinct, relatively prime cycle lengths, the length of the composite sequence created by the combined sequence of secondary pseudo-random number generators would have a cycle length equal to the product of the separate cycle lengths. For example, with k set equal to 4 and secondary pseudo-random number generator cycle lengths of 715,999,981, 714,673,789, 700,943,927 and 687,956,333, the length of the cycle of combinations would equal 2.47×10³⁵ before the pattern of combinations would begin to repeat.

The variable offset matrices B_{l,n} . . . B_{j,n} are determined by secondary pseudo-random number generators or other processes. For instance, a simple list of 113 possible values for Bₗ could be compiled and the variation in the sequence of B_{l,n} as n goes from 1 to 113 would consist of selecting the next entry from the list. As the list is exhausted, the selection would return to the beginning of the list. Similar lists could be used for B₂ through Bⱼ with each variation being chosen from the sequences in the lists. The number of items in the lists are ideally chosen to be relatively prime, that is, no count of items in any of the lists would share a common factor with another. The length of the composite sequence created by this combined sequence of lists would have a cycle length equal to the product of the number of items in each list. Thus, with j set equal to 4 and list lengths of 113, 109, 99 and 97, the length of the cycle of combinations would equal 118,280,151 before the pattern of combinations would begin to repeat. Instead of lists, each B_{l,n} . . . B_{j,n} could be determined by a secondary pseudo-random number generator, ideally with the cycle length of each pseudo-random number generator distinct from the others including those of the transition matrices A. The secondary pseudo-random number generators could be of virtually any form including the classical LCG or any of the variations mentioned above. With distinct, relatively prime cycle lengths, the length of the composite sequence created by the combined sequence of secondary pseudo-random number generators would have a cycle length equal to the product of the separate cycle lengths. For example, with j set equal to 4 and secondary pseudo-random number generator cycle lengths of 42,517,061, 43,477,631, 37,533,169 and 34,824,227, the length of the cycle of combinations would equal 2.42×10³⁰ before the pattern of combinations would begin to repeat.

Using secondary pseudo-random number generators for the transition matrices A and also for the offset matrices B with composite cycle lengths of 2.47×10³⁵ and 2.42×10³⁰ would yield a primary MVRM process pseudo-random number generator with a cycle length of 5.96×10⁶⁵.

The modulus operators m_{l,n} . . . m_{i,n} are determined by secondary pseudo-random number generators or other processes. For instance, a simple list of 71 possible values for mₗ could be compiled and the variation in the sequence of m_{l,n} as n goes from 1 to 71 would consist of selecting the next entry from the list. As the list is exhausted, the selection would return to the beginning of the list. Similar lists could be used for m₂ through mᵢ with each variation being chosen from the sequences in the lists. The number of items in the lists are ideally chosen to be relatively prime, that is, no count of items in any of the lists would share a common factor with another. The length of the composite sequence created by this combined sequence of lists would have a cycle length equal to the product of the number of items in each list. Thus, with i set equal to 3 and list lengths of 71, 67 and 64, the length of the cycle of combinations would equal 304,448 before the pattern of combinations would begin to repeat. Instead of lists, each m_{l,n} . . . M_{i,n} could be determined by a secondary pseudo-random number generator, advantageously with the cycle length of each pseudo-random number generator distinct from the others including those of the transition matrices A and of the offset matrices B. The secondary pseudo-random number generators could be of virtually any form including the classical LCG or any of the variations mentioned above. With distinct, relatively prime cycle lengths, the length of the composite sequence created by the combined sequence of secondary pseudo-random number generators would have a cycle length equal to the product of the separate cycle lengths. For example, with i set equal to 3 and secondary pseudo-random number generator cycle lengths of 7,337, 6,479 and 9,503, the length of the cycle of combinations would equal 4.52×10¹¹ before the pattern of combinations would begin to repeat.

Use of secondary pseudo-random number generators for the modulus operators with composite cycle lengths of 4.52×10¹¹ in addition to secondary pseudo-random number generators for the transition matrices A and for the offset matrices B with composite cycle lengths of 2.47×10³⁵ and 2.42×10^{30,} respectively, could yield a primary MVRM process pseudo-random number generator with a cycle length of 2.69×10⁷⁷. The cycle length of pseudo-random number generators with integrated varying modulus operators is difficult to evaluate since no theoretical basis for making such evaluation has yet been developed. However, because the system is composed of several independent elements each of which has quite long cycle lengths, the composite result could well be equivalent to the product of those cycle lengths leaving a very long resulting cycle length.

In order to assure the very long cycle lengths, an alternative form of the multiple variable recursive matrix (MVRM) pseudo-random number generator process of the invention could be used that has the form of Xₙ=((A_{l,n}Xₙ₋ₗ+ . . . +A_{k,n}Xₙ₋ₖ+B_{l,n}+ . . . +B_{j,n}) mod m_{l,n}) . . . mod m_{i,n} for the primary candidate output cycle component and the actual output values are generated through the multiple modulus operation Zₙ=(Xₙ mod r_{l,n}) . . . mod r_{g,n}, that is, the n^{th} actual output value is generated by applying multiple varying modulus operators to the n^{th} value of the candidate output matrix. The initial modulus operators m_{l,n} . . . m_{i,n} for the candidate output matrix could be chosen to accommodate the word-length constraints of the computer system and should advantageously be large prime numbers.

For either embodiment of the MVRM generator, the MVRM multiple modulus version or the alternative form described in the preceding paragraph, the modulus operators should ideally be chosen to be relatively prime to each other. The final modulus operator determines the range of the actual output values, e.g., choosing 256 as the final operator value creates a range of actual output values from 0 to 255. Other modulus operator values, whether chosen from lists, by secondary pseudo-random number generators, or by some other method, should fall into descending value order between the first operator (which should be the largest) and the final operator (which should be the smallest). All of the modulus operators should ideally be relatively prime to each other. Thus, if 256 were chosen as the final modulus operator, all of the other operators should be relatively prime odd numbers (to be relatively prime to 256 which is an even number).

In order to generate an equally and uniformly distributed set of actual output values, certain results from each of the modulus operation steps would have to be discarded according to the relationship of the modulus operators. For instance, if the value of m_{l,n} mod m_{2,n} was equal to 117, then 117 of the possible intermediate results would need to be discarded to assure the uniformity of the generated candidate or actual output distribution. Either the first 117, the final 117, or some arbitrary range of 117 of the possible intermediate output results could be discarded. To discard the first 117, the exclusion condition would be Xₙ<117; to discard the final 117, the exclusion condition would be Xₙ>=m_{l,n}−117. The discarding process would be similarly applied to each subsequent set of modulus operations, e.g., m_{2,n} mod m_{3,n}, m_{3,n} mod m_{4,n} . . . m_{i-l,n} mod m_{i,n}, where m_{i,n} is the final modulus operator.

Another variation of the multiple modulus process would be to calculate Xₙ=((A^{x}_{l,n}Xₙ₋ₗ+ . . . +A^{x}_{k,n}Xₙ₋ₖ+B^{x}_{l,n}+ . . . +B^{x}_{j,n}) mod m^{x}_{l,n}) . . . mod m^{x}_{i,n} for the first primary candidate output cycle component and Yₙ=((A^{y}_{l,n}Yₙ₋ₗ+ . . . +A^{y}_{k,n}Yₙ₋ₖ+B^{y}_{l,n}+ . . . +B^{y}_{j,n}) mod m^{y}_{l,n}) . . . mod m^{y}_{i,n} for the second primary candidate output cycle component and the actual output values would be generated through multiple modulus operations applied to the sum of Xₙ and Yₙ as Zₙ=((Xₙ+Yₙ) mod m^{z}_{l,n}) . . . mod m^{z}_{i,n}.

The process of the MVRM pseudo-random number generator could also be specified to assure that each candidate output value matrix of the form of Xₙ=((A_{l,n}Xₙ₋ₗ+ . . . +A_{k,n}Xₙ₋ₖ+B_{l,n}+ . . . +B_{j,n}) mod m_{l,n}) . . . mod m_{i,n} was a non-invertible matrix. This characteristic could be introduced by appropriate modification of the final offset matrix component B_{j,n} to assure that the candidate output value matrix Xₙ was non-invertible. Were each of the candidate output value matrices non-invertible, then the multiplicative components created by the transition matrices (e. g., A_{l,n}Xₙ₋ₗ) would also be non-invertible regardless of the invertibility of the transition matrices A. However, the transition and offset matrices may themselves be non-invertible as contributing components of the resulting candidate output value matrix.

All of the elements or only part of the elements of the candidate output value matrix Xₙ could be used as the actual output values of the pseudo-random number generator. Any remaining elements that are not used as pseudo-random number generator actual output values could be stored in the storage register and still contribute to the determination of subsequent candidate output value matrix results.

The MVRM pseudo-random number generator claimed herein incorporates several components, each of which has distinct effects on the overall cycle length of the pseudo-random number generator process. In general, the use of long-cycle secondary pseudo-random number generators to determine the values of the transition matrices, offset matrices, and modulus operators should contribute to MVRM pseudo-random number generator cycles that are exceedingly long. The cycle length of pseudo-random number generators of the MVRM type is difficult to evaluate since no theoretical basis for making such evaluation has yet been developed. However, because the system is composed of several independent elements each of which has quite long cycle lengths, the composite result should be equivalent to the product of those cycle lengths leaving a very long resulting combined cycle length.

An advantage of the present invention is that it presents a new unified framework for incorporating a large number of options into the pseudo-random number generator process creating nearly innumerable sets of alternative pseudo-random number sequences.

### BRIEF DESCRIPTION OF THE DRAWINGS

FIG. 1 is a block diagram depicting the functional components of a MVRM pseudo-random number generator, according to the invention claimed herein.

FIG. 2 is a block diagram depicting a general implementation of functional components of the MVRM pseudo-random number generator, according to the invention claimed herein.

FIG. 3 is a block diagram depicting the functional components of a MVRM pseudo-random number generator with both primary and secondary variable modulus reductions, according to the invention claimed herein.

FIG. 4 is a block diagram depicting a general implementation of functional components of the MVRM pseudo-random number generator with both primary and secondary variable modulus reductions, according to the invention claimed herein.

FIG. 5 is a block diagram depicting an implementation of the uniform variable modular reduction functional component of the MVRM pseudo-random number generator converting the intermediate output matrix Xₜₑₘₚ to a uniformly distributed primary candidate output value matrix Xₙ, according to the invention claimed herein.

FIG. 6 is a block diagram depicting an implementation of the uniform variable modular reduction functional component of the MVRM pseudo-random number generator converting the primary candidate output value matrix Xₙ to a uniformly distributed secondary candidate output value matrix Zₙ, according to the invention claimed herein.

FIG. 7 is a block diagram depicting a dual-sequence implementation of the MVRM pseudo-random number generator of the claimed invention, with a single variable modular reduction component.

FIG. 8 is a block diagram depicting an implementation of the MVRM pseudo-random number generator of the claimed invention, including an invertibility evaluation module for the creation of non-invertible candidate output value matrices.

### DESCRIPTION OF THE PREFERRED EMBODIMENT

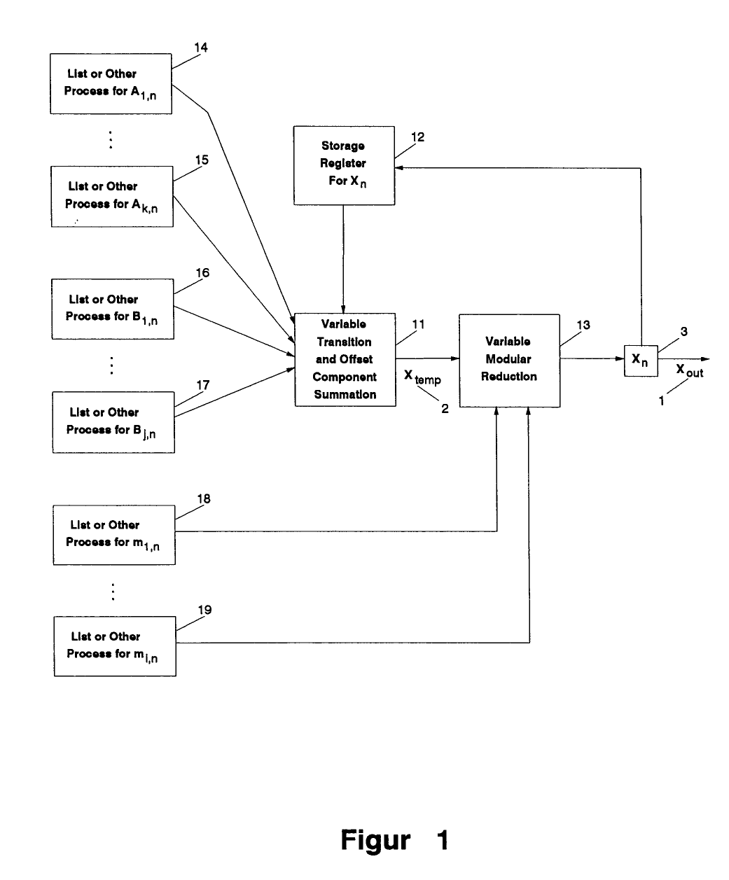

Referring to FIG. 1, a block diagram of the pseudo-random number generator system of the claimed invention is shown which incorporates a transition and offset summation process 11, a storage register 12 for initial and previously generated values of the primary candidate output matrix sequence Xₙ 3, a variable modular reduction process 13, a list or other process 14 for creating a value for transition matrix A_{l,n}, a list or other process 15 for creating values for all other transition matrices through A_{k,n}, a list or other process 16 for creating a value for offset matrix B_{l,n}, a list or other process 17 for creating values for all other offset matrices through B_{j,n}, a list or other process 18 for creating a value for modulus operator m_{l,n}, and a list or other process 19 for creating values for all other modulus operators through Mᵢₙ. The values of the transition matrices A_{l,n} 24 through A_{k,n} 25 and of the offset matrices B_{l,n} 26 through B_{j,n} 27 along with the previously created or initial values of the primary candidate output matrices Xₙ 3 from the storage register 12 are provided to the transition and offset summation process 11 where they are aggregated through matrix multiplication and addition operations to create an intermediate value of the primary candidate output matrix shown as Xₜₑₘₚ 2. The intermediate value Xₜₑₘₚ 2 is then sent to the variable modular reduction process 13 where the modulus operators m_{l,n} 28 through M_{i,n} 29 are applied and resulting values evaluated for retention or removal to generate the primary candidate output matrix sequence Xₙ 3. The actual output values of the pseudo-random number generator Xₒᵤₜ 1 are composed of all or some of the elements of the primary candidate output matrix Xₙ 3. Any remaining elements from the primary candidate output matrix Xₙ 3 that are not used as pseudo-random number generator actual output values Xₒᵤₜ 1 could be stored in the storage register 12 and still contribute to the determination of subsequent primary candidate output matrix results.

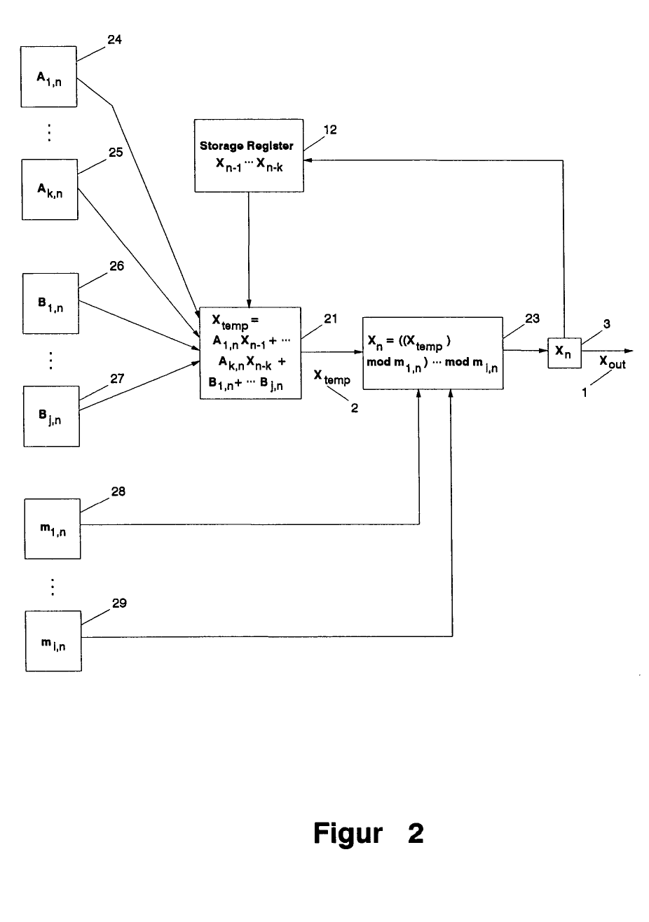

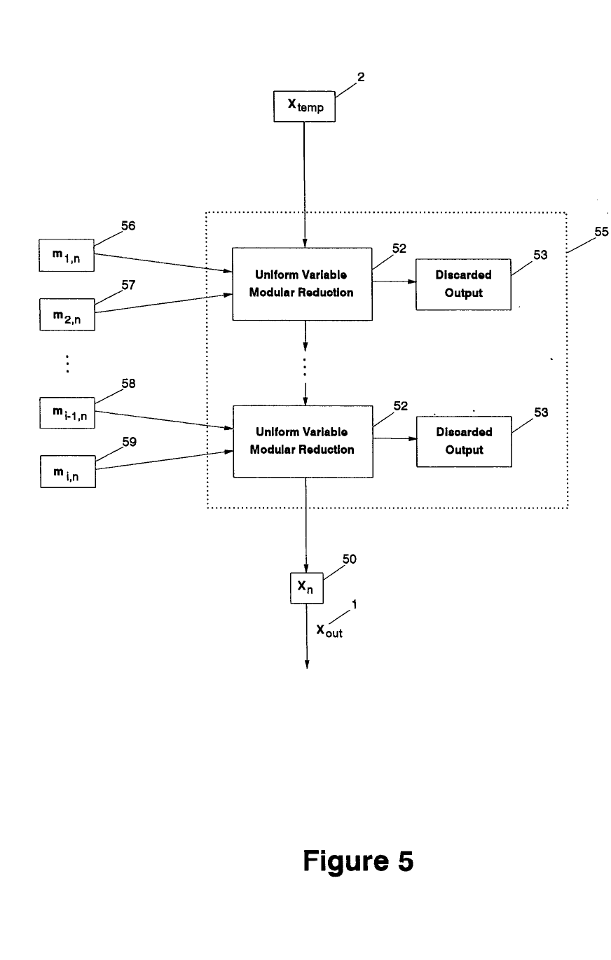

In FIG. 2, one embodiment of the general pseudo-random number generator system of the invention is shown. The system shown in FIG. 2 details the transition and offset summation process 21 of the invention with the particular form Xₜₑₘₚ=A_{l,n}Xₙ₋ₗ+ . . . +A_{k,n}Xₙ₋ₖ+B_{l,n}+ . . . +B_{j,n} using the transition matrices A_{l,n} 24 through A_{k,n} 25, the offset matrices B_{l,n} 26 through B_{j,n} 27, and the previously created or initial values of the primary candidate output matrices Xₙ₋ₗ through Xₙ₋ₖ from the storage register 12. The intermediate value Xₜₑₘₚ 2 is then sent to the variable modular reduction process 23 with the form Xₙ=((Xₜₑₘₚ) mod m_{l,n}) . . . mod m_{i,n} where the modulus operators m_{l,n} through m_{i,n} are applied and resulting values evaluated for retention or removal to generate the primary candidate output matrix sequence Xₙ 3. The retention/removal component of the variable modular reduction process when used to create uniformly distributed values is shown in more detail in FIG. 5.

The actual output values Xₒᵤₜ 1 of the pseudo-random number generator are composed of all or some of the elements of the primary candidate output matrix Xₙ 3. Any remaining elements from the primary candidate output matrix Xₙ 3 that are not used as pseudo-random number generator actual output values Xₒᵤₜ 1 could be stored in the storage register 12 and still contribute to the determination of subsequent primary candidate output matrix results. The values for the transition matrices A_{l,n} 24 through A_{k,n} 25 are created by secondary pseudo-random number generators, are taken from pre-determined lists, or are created by other processes before being sent to the transition and offset summation process 21. The values for the offset matrices B_{l,n} 26 through B_{j,n} 27 are created by secondary pseudo-random number generators, are taken from pre-determined lists, or are created by other processes before being sent to the transition and offset summation process 21. The values for the modulus operators m_{l,n} 28 through M_{i,n} 29 are created by secondary pseudo-random number generators, are taken from pre-determined lists, or are created by other processes before being sent to the variable modular reduction process 23.

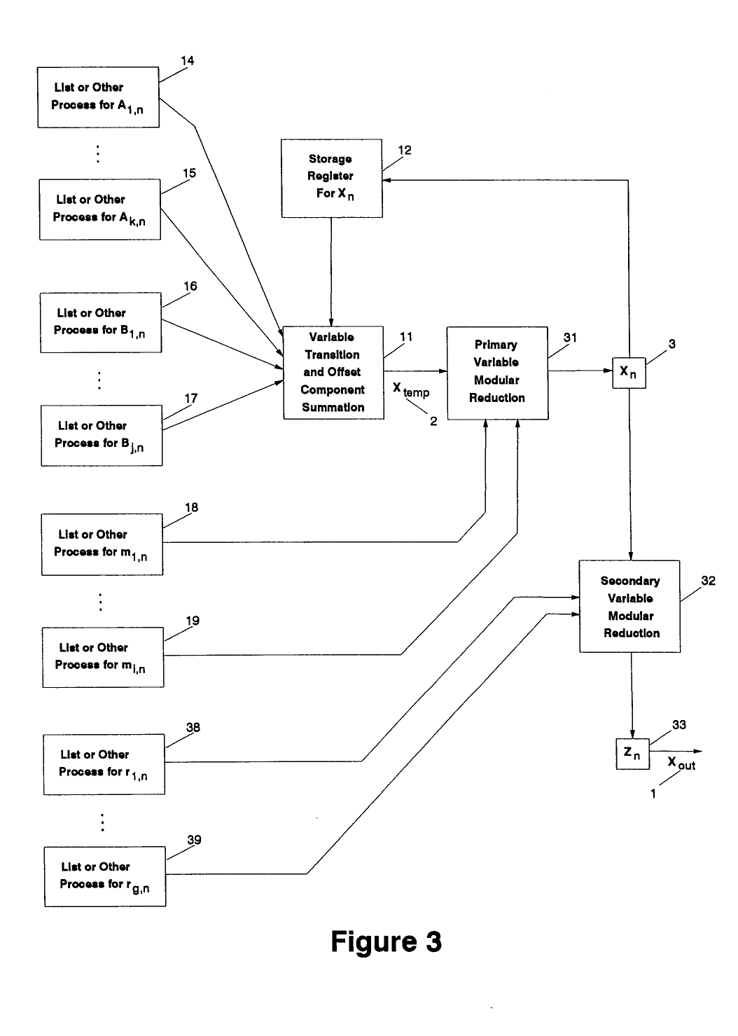

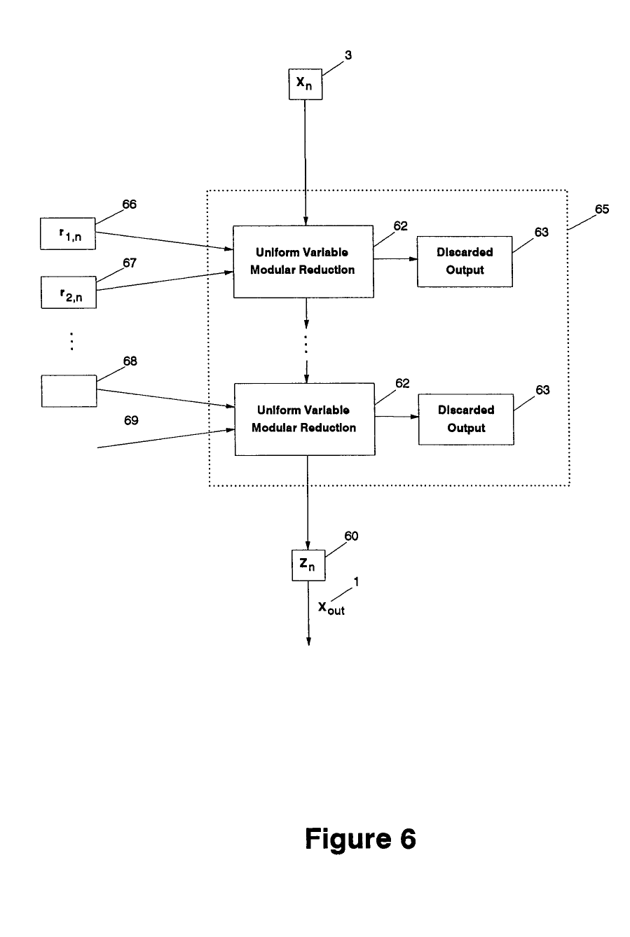

In FIG. 3, an alternative embodiment of an implementation of the general pseudo-random number generator system of the invention is shown. The system shown in FIG. 3 includes both primary variable modular reduction 31 and secondary variable modular reduction 32 components. As in the implementation shown in FIG. 1, the process incorporates a transition and offset summation process 11; a storage register 12 for initial and previously generated values of the primary candidate output matrix sequence Xₙ 3; a primary variable modular reduction process 31; lists or other processes for creating transition matrices A_{l,n} 14 through A_{k,n} 15; lists or other processes for creating offset matrices B_{l,n} 16 through B_{j,n} 17; and lists or other processes for creating modulus operators m_{l,n} 18 through m_{i,n} 19. The transition and offset summation process 11 creates an intermediate value of the primary candidate output matrix Xₜₑₘₚ 2. The intermediate value Xₜₑₘₚ 2 is then sent to the primary variable modular reduction process 31 where the modulus operators m_{l,n} 18 through M_{i,n} 19 are applied and resulting values evaluated for retention or removal to generate the primary candidate output matrix sequence Xₙ 3. The primary candidate output matrix sequence Xₙ 3 is then sent to the secondary variable modular reduction process 32 where the modulus operators r_{l,n} 38 through r_{g,n} 39 are applied and resulting values evaluated for retention or removal to generate the secondary candidate output matrix sequence Zₙ 33. The actual output values of the pseudo-random number generator Xₒᵤₜ 1 are composed of all or some of the elements of the secondary candidate output matrix Zₙ 33. The primary variable modular reduction process 31 may be implemented as a uniform variable modular reduction functional component as shown in FIG. 5 converting the intermediate output matrix Xₜₑₘₚ 2 to a uniformly distributed primary candidate output value matrix Xₙ 3. Similarly, the secondary variable modular reduction process 32 may be implemented as a uniform variable modular reduction functional component as shown in FIG. 6 converting the primary candidate output value matrix Xₙ 3 to a uniformly distributed secondary candidate output value matrix Zₙ 33.

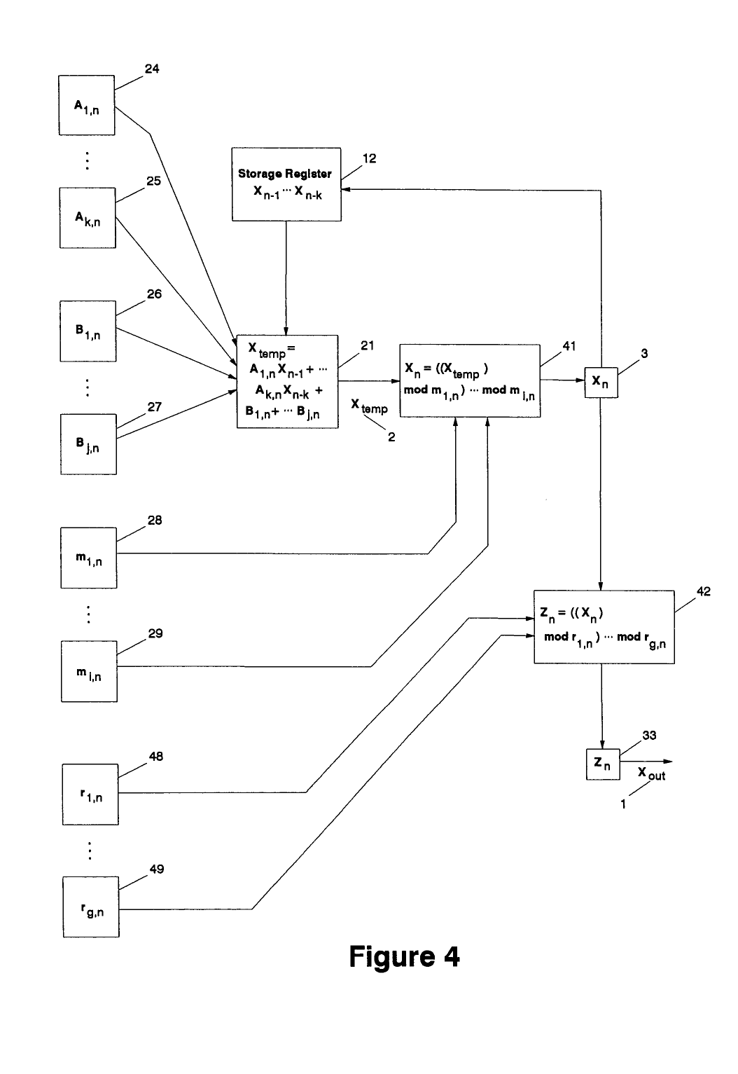

In FIG. 4, one embodiment of the alternative implementation of FIG. 3. is shown. As in the embodiment of FIG. 2., the transition and offset summation process 21 of the invention takes the form Xₜₑₘₚ=A_{l,n}Xₙ₋ₗ+ . . . +A_{k,n}Xₙ₋ₖ+B_{l,n}+ . . . +B_{j,n} using the transition matrices A_{l,n} 24 through A_{k,n} 25, the offset matrices B_{l,n} 26 through B_{j,n} 27, and the previously created or initial values of the primary candidate output matrices Xₙ₋ₗ through Xₙ₋ₖ from the storage register 12. The intermediate value Xₜₑₘₚ 2 is then sent to the primary variable modular reduction component 41 with the form Xₙ=((Xₜₑₘₚ) mod m_{l,n}) . . . mod m_{i,n} to generate the candidate output matrix Xₙ 3. Resulting values of the candidate output matrix Xₙ 3 are evaluated for retention or removal prior to storage in the storage register 12 to generate subsequent iterations of the primary candidate output matrix 3. The primary candidate output matrix Xₙ 3 also is sent to the secondary variable modular reduction process 42 with the form Zₙ=((Xₙ) mod r_{l,n}) . . . mod r_{g,n} where the modulus operators r_{l,n} 48 through r_{g,n} 49 are applied and resulting values evaluated for retention or removal to generate the secondary candidate output matrix zₙ 33. The actual output values of the pseudo-random number generator Xₒᵤₜ 1 are composed of all or some of the elements of the secondary candidate output matrix Zₙ 33. Any remaining elements from the secondary candidate output matrix Zₙ 33 that are not used as pseudo-random number generator actual output values Xₒᵤₜ 1 are discarded. As in the embodiment of FIG. 2., the values for the transition matrices A_{l,n} 24 through A_{k,n} 25 are created by secondary pseudo-random number generators, are taken from pre-determined lists, or are created by other processes before being sent to the transition and offset summation process 21. The values for the offset matrices B_{l,n} 26 through B_{j,n} 27 are created by secondary pseudo-random number generators, are taken from pre-determined lists, or are created by other processes before being sent to the transition and offset summation process 21. The values for the modulus operators m_{l,n} 28 through M_{i,n} 29 are created by secondary pseudo-random number generators, are taken from pre-determined lists, or are created by other processes before being sent to the primary variable modular reduction process 41. The values for the modulus operators r_{l,n} 48 through r_{g,n} 49 are created by secondary pseudo-random number generators, are taken from pre-determined lists, or are created by other processes before being sent to the secondary variable modular reduction process 42.

In FIG. 5, the retention and discarding procedures of the primary uniform variable modular reduction process are shown in detail. The intermediate value Xₜₑₘₚ 2 is provided to the primary uniform variable modular reduction process 55. Each successive pair of modulus operators starting with m_{l,n} 56 and m_{2,n} 57 are used in the uniform variable modular processor 52 in the form Xₜₑₘₚ₂=((Xₜₑₘₚ) mod m_{l,n}) mod m_{2,n}. The uniformity of the distribution of the possible values of Xₜₑₘₚ₂ over the range of 0 to (m_{2,n-l}) is assured by discarding a certain number of candidate output values 53 from the process. The number of values to be discarded is determined as m_{l,n} mod m_{2,n} which would be a number greater than 0 if the modulus operators m_{l,n} 56 and m_{2,n} 57 were chosen to be relatively prime. The number of values to be discarded can be realized by discarding the first m_{l,n} mod m_{2,n} elements of Xₜₑₘₚ or by discarding the last m_{l,n} mod m_{2,n} elements of Xₜₑₘₚ. The process is successively repeated by providing each intermediate value to the primary uniform variable modular processor 52 for each successive pair of modulus operators. For example, the next successive pair of modulus operators (m_{2,n} and m_{3,n}) would be used in the uniform variable modular processor 52 in the form Xₜₑₘₚ₃=((Xₜₑₘₚ₂) mod m_{2,n}) mod m_{3,n}. However, since Xₜₑₘₚ₂ was already created with the operation of mod m_{2,n}, the repetition of that step is unnecessary and simplifies to Xₜₑₘₚ₃=(Xₜₑₘₚ₂) mod m_{3,n}. As before, the uniformity of the distribution of the possible values of Xₜₑₘₚ₃ over the range of 0 to (m₃−1) is assured by discarding the number of values determined as m_{2,n} mod m_{3,n}. The process is successively repeated by providing each intermediate value to the uniform variable modular processor 52 for each successive pair of modulus operators until the final set of m_{i-l,n} 58 and m_{i,m} 59 are used. In the final step, the uniform variable modular processor 52 has the form Xₜₑₘₚᵢ=((Xₜₑₘₚᵢ₋ₗ) mod m_{i-l,n}) mod m_{i,n} which again simplifies to Xₜₑₘₚᵢ=(Xₜₑₘₚᵢ₋ₗ) mod m_{i,n}. The uniformity of the distribution of the possible values of Xₜₑₘₚᵢ over the range of 0 to (m_{i,n}−1) is assured by discarding a certain number of primary candidate output values 53 from the process. The number of values to be discarded is determined as m_{i-l,n} mod m_{i,n} which is greater than 0 since M_{i-l,n} 58 and m_{i,n} 59 are relatively prime. The appropriate number of values to be discarded can be realized by discarding the first m_{i-l,n} mod m_{i,n} elements of Xₜₑₘₚᵢ₋ₗ or by discarding the last m_{i-l,n} mod m_{i,n} elements of Xₜₑₘₚᵢ₋ₗ. The values of Xₜₑₘₚᵢ in the final step are sent to the primary candidate output matrix Xₙ 50 as the results of the primary uniform variable modular reduction process 55.

In FIG. 6, the retention and discarding procedures of the secondary uniform variable modular reduction process are shown in detail. The primary candidate output matrix Xₙ 3 is provided to the secondary uniform variable modular reduction process 65. Each successive pair of modulus operators starting with r_{l,n} 66 and r_{2,n} 67 are used in the uniform variable modular processor 62 in the form X_{secondary2}=((Xₙ) mod r_{l,n}) mod r_{2,n}. The uniformity of the distribution of the possible values of X_{secondary2} over the range of 0 to (r_{2,n}−1) is assured by discarding a certain number of candidate output values 63 from the process. The number of values to be discarded is determined as r_{l,n} mod r_{2,n} which should be a number greater than 0 since r_{l,n} 66 and r_{2,n} 67 are relatively prime. The number of values to be discarded can be realized by discarding the first r_{l,n} mod r_{2,n} elements of X_{secondary} or by discarding the last r_{l,n} mod r_{2,n} elements of X_{secondary}. The process is successively repeated by providing each intermediate value to the secondary uniform variable modular processor 62 for each successive pair of modulus operators. For example, the next successive pair of modulus operators (r_{2,n} and r_{3,n}) would be used in the uniform variable modular processor 62 in the form X_{secondary3}=((X_{secondary2}) mod r_{2,n}) mod r_{3,n}. However, since X_{secondary2} was already created with the operation of mod r_{2,n}, the repetition of that step is unnecessary and simplifies to X_{secondary3}=(X_{secondary2}) mod r_{3,n}. As before, the uniformity of the distribution of the possible values of X_{secondary3} over the range of 0 to (r_{3,n}−1) is assured by discarding the number of values determined as r_{2,n} mod r_{3,n}. The process is successively repeated by providing each intermediate value to the uniform variable modular processor 62 for each successive pair of modulus operators until the final set of r_{g-l,n} 68 and r_{g,n} 69 are used. In the final step, the uniform variable modular processor 62 has the form X_{secondaryg}=((X_{secondaryg-l}) mod r_{g-l,n}) mod r_{g,n} which again simplifies to X_{secondaryg}=(X_{secondaryg-l}) mod r_{g,n}. The uniformity of the distribution of the possible values of X_{secondaryg} over the range of 0 to (r_{g,n}−1) is assured by discarding a certain number of secondary candidate output values 63 from the process. The number of values to be discarded is determined as r_{g-l,n} mod r_{g,n} which is greater than 0 since r_{g-l,n} 68 and r_{g,n} 69 are relatively prime. The appropriate number of values to be discarded can be realized by discarding the first r_{g-l,n} mod r_{g,n} elements of X_{secondaryg-l} or by discarding the last r_{g-l,n} mod r_{g,n} elements of X_{secondaryg-l}. The values of X_{secondaryg} in the final step are sent to the secondary candidate output matrix Zₙ 60 as the results of the secondary uniform variable modular reduction process 65. The actual output values of the pseudo-random number generator Xₒᵤₜ 1 are composed of all or some of the elements of the secondary candidate output matrix Zₙ 60.

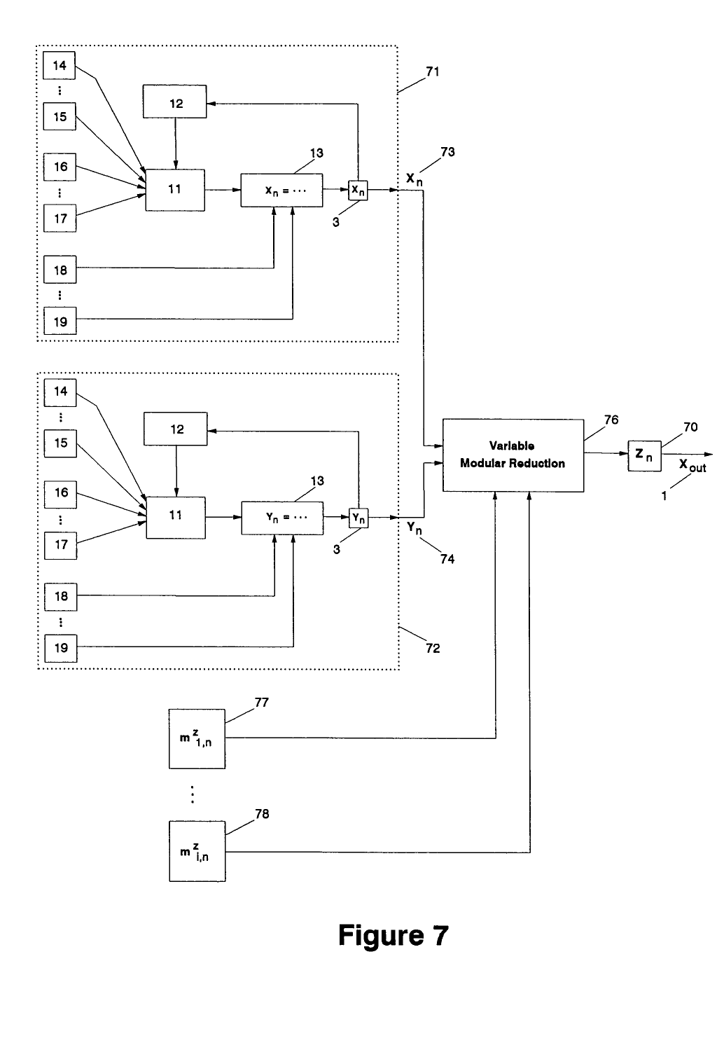

In FIG. 7, another alternative implementation of the general pseudo-random number generator system of the invention that includes two (or more) independent MVRM modules 71, 72 and a separate uniform variable modular reduction component 76 is shown in detail. Each of the independent MVRM modules 71, 72 operates as in the general version with the transition and offset summation process 11, the previously created values from the storage register 12, and the variable modular reduction process 13 creating the candidate output values Xₙ 73 or Yₙ 74. The variable modular reduction process 76 accepts the independent candidate output values Xₙ 73 and Yₙ 74 along with the variable modulus operators m^{z}_{l,n} 77 through m^{z}_{j,n} 78 to create the candidate output matrix Zₙ 70 of the alternative implementation of the pseudo-random number generator. The specific actual output values Xₒᵤₜ 1 are composed of all or some of the elements of the variable modulus candidate output matrix Zₙ 70. The values for the modulus operators m^{z}_{l,n} 77 through m^{z}_{j,n} 78 are created by secondary pseudo-random number generators, are taken from pre-determined lists, or are created by other processes before being sent to the variable modular reduction process 76.

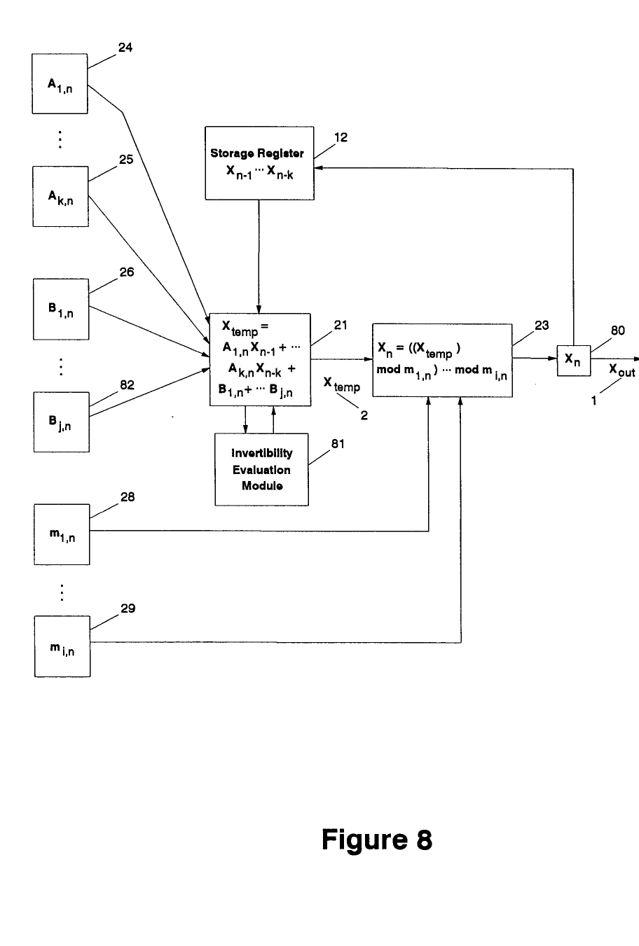

FIG. 8 portrays a particular embodiment of the general pseudo-random number generator system of the invention that includes a component assuring that the candidate output matrix Xₙ 80 cannot be inverted. FIG. 8 shows essentially the same system that was shown in FIG. 2 including details of the transition and offset summation process 21 with the form Xₜₑₘₚ=A_{l,n}Xₙ₋ₗ+ . . . +A_{k,n}Xₙ₋ₖ+B_{l,n}+ . . . +B_{j,n} using the transition matrices A_{l,n} 24 through A_{k,n} 25, the offset matrices B_{l,n} 26 through B_{j,n} 82, and the previously created or initial values of the primary candidate output matrices Xₙ₋ₗ through Xₙ₋ₖ from the storage register 12. However, unlike the system previously shown in FIG. 2, the non-invertible version of FIG. 8 includes an invertibility evaluation module 81 that evaluates the final offset matrix B_{j,n} 82 and makes adjustments based on the characteristics of Xₜₑₘₚ 2 not including B_{j,n} 82 to assure that the result of the transition and offset summation process 21 yields a matrix that cannot be inverted. That non-invertible intermediate value of Xₜₑₘₚ 2 is then sent to the variable modular reduction process 23 with the form Xₙ=((Xₜₑₘₚ) mod m_{l,n}) . . . mod m_{j,n} where the modulus operators m_{l,n} 28 through m_{j,n} 29 are applied to generate the primary non-invertible candidate output matrix sequence Xₙ 80. For uniform variable modular reduction the retention/removal component of the process was shown in more detail in FIG. 5. The actual output values of the pseudo-random number generator Xₒᵤₜ 1 are composed of all or some of the elements of the primary non-invertible candidate output matrix Xₙ 80. Any remaining elements from the primary non-invertible candidate output matrix Xₙ 80 that are not used as pseudo-random number generator actual output values Xₒᵤₜ 1 could be stored in the storage register 12 and still contribute to the determination of subsequent primary non-invertible candidate output matrix results. The values for the transition matrices A_{l,n} 24 through A_{k,n} 25 are created by secondary pseudo-random number generators, are taken from pre-determined lists, or are created by other processes before being sent to the transition and offset summation process 21. The values for the offset matrices B_{l,n} 26 through B_{j,n} 82 are created by secondary pseudo-random number generators, are taken from pre-determined lists, or are created by other processes before being sent to the transition and offset summation process 21 except that the final offset value of B_{j,n} 82 is evaluated and adjusted by the invertibility evaluation module 81 to assure that the intermediate output matrix Xₜₑₘₚ 2 cannot be inverted. The values for the modulus operators m_{l,n} 28 through m_{j,n} 29 are created by secondary pseudo-random number generators, are taken from pre-determined lists, or are created by other processes before being sent to the uniform variable modular reduction process 23.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

1. A method of generating a pseudo-random number, said method comprising the steps of:
(a) Establish initialization values for output series of pseudo-random number matrices Xₗ-Xₖ;
(b) Establish initialization values for variable transition matrices A_{l,1}-A_{k,1};
(c) Establish initialization values for variable offset matrices B_{l,1}- B_{j,1};
(d) Establish first modulus operators m_{l,1}-m_{i,1};
(e) Apply said transition matrices A_{l,1}- A_{k,1} to said output series of pseudo-random number matrices Xₗ-Xₖ to generate a first intermediate matrix value X_{firsttemp};
(f) Apply said offset matrices B_{l,1}-B_{j,1} to said first intermediate matrix value X_{firsttemp} to generate a second intermediate matrix value Xₜₑₘₚ; and
(g) Sequentially apply said first modulus operators m_{l,1}-m_{i,1} to said second intermediate matrix value Xₜₑₘₚ to generate an output value of pseudo-random number matrix Xₙ from which at least one pseudo-random number is extracted.

2. A method of generating a plurality of pseudo-random numbers, said method comprising the steps of:
(a) Establish initialization values for output series of pseudo-random number matrices Xₗ-Xₖ;
(b) Establish initialization values for variable transition matrices A_{l,1}-A_{k,1};
(c) Establish initialization values for variable offset matrices B_{l,1}-B_{j,1};
(d) Establish first modulus operators m_{l,1}-m_{i,1};
(e) Apply said transition matrices A_{l,1}-A_{k,1} to said output series of pseudo-random number matrices Xₗ-Xₖ to generate a first intermediate matrix value X_{firsttemp};
(f) Apply said offset matrices B_{l,1}-B_{j,1} to said first intermediate matrix value X_{firsttemp} to generate a second intermediate matrix value Xₜₑₘₚ;
(g) Sequentially apply said first modulus operators m_{l,1}-m_{i,1} to said second intermediate matrix value Xₜₑₘₚ to generate a first output value of pseudo-random number matrix Xₙ from which at least one pseudo-random number is extracted;
(h) Store said first output value matrix Xₙ in a storage register to establish an updated output series of pseudo-random number matrices;
(i) Update said transition matrices A_{l,1}-A_{k,1} through updating process to create updated transition matrices A_{l,2}-A_{k,2};
(j) Apply said updated transition matrices A_{l,2}-A_{k,2} to said updated output series of pseudo-random number matrices Xₙ₋ₖ₊ₗ-Xₙ to generate an updated first intermediate matrix value X_{firsttemp};
(k) Update said offset matrices B_{l,1}-B_{j,1} through updating process to create updated offset matrices B_{l,2}- B_{j,2};
(1) Apply said updated offset matrices B_{l,2}-B_{j,2} to said updated first intermediate matrix value X_{firsttemp} to generate an updated second intermediate matrix value Xₜₑₘₚ;
(m) Update said first modulus operators m_{l,1}-m_{i,1} through updating process to create updated first modulus operators m_{l,2}-m_{i,2};
(n) Sequentially apply said updated first modulus operators m_{l,2}-m_{i,2} to said updated second intermediate matrix value Xₜₑₘₚ to generate a second output value of pseudo-random number matrix X₊ₗ from which at least one pseudo-random number is extracted; and
(o) Store said second pseudo-random number matrix Xₙ₊ₗ in said storage register of pseudo-random number matrices.

3. A method of generating a plurality of pseudo-random numbers according to claim 2, wherein said steps i. through o. are repeated to generate a desired number d of pseudo-random number matrices X_{n+d} from which a plurality of pseudo-random numbers are extracted.

4. A method according to claim 2 further comprising the step of:
Selecting a first subset of said pseudo-random numbers from said updated output series of pseudo-random number matrices.

5. A method according to claim 1, claim 2, or claim 3, wherein k=1 so that a single variable transition matrix is used.

6. A method according to claim 1, claim 2, or claim 3, where j=1 so that a single variable offset matrix is used.

7. A method according to claim 1, claim 2, or claim 3, where i=1 so that a single modulus operator is used.

8. A method according to claim 2, further comprising the steps of:
(a) Establish second modulus operators r_{l,1}-r_{g,1};
(b) Sequentially apply and update second modulus operators r_{l,1}-r_{g,1}, r_{l,2 -r}_{g,2}, . . . r_{l,n+d-k-r}_{g,n+d-k} to said updated output series of pseudo-random number matrices to generate a second output series of pseudo-random number matrices.

9. A method according to claim 8, further comprising the step of:
Selecting a second subset of said pseudo-random numbers from said second output series of pseudo-random number matrices.

10. A method according to claim 1, claim 2, or claim 3:
(a) Wherein said first modulus operators m_{l,1}-m_{j,1}, m_{l,2}-m_{j,2}, . . . m_{l,n+d-k-m}_{j,n+d-k} comprise a uniform variable modular reduction, and
(b) Further comprising the step of discarding certain pseudo-random numbers which are not uniformly distributed.

11. A method according to claim 8:
(a) Wherein said second modulus operators r_{l,1}-r_{g,1}, r_{l,2}-r_{g,2}, . . . r_{l,n+d-k-r}_{g,n+d-k} comprise a uniform variable modular reduction, and
(b) Further comprising the step of discarding certain pseudo-random numbers which are not uniformly distributed.

12. A method according to claim 2 or claim 3, further comprising the steps of:
(a) Create at least one other storage register of pseudo-random number matrices by separately taking steps a-o;
(b) Create temporary composite pseudo-random number matrices by combining each resulting storage register of pseudo-random number matrices through at least one mathematical operation;
(c) Create final composite pseudo-random number matrices by applying variable modular reduction to said temporary composite pseudo-random number matrices; and
(d) Select a subset of pseudo-random numbers from said resulting final composite pseudo-random number matrices

13. A method according to claim 1, claim 2, or claim 3 further comprising:
(a) Apply an invertibility evaluation module to each second intermediate matrix value Xₜₑₘₚ;
(b) Adjust offset matrices B_{l,1}-B_{j,1}, B_{l,2}-B_{j,2}, . . . B_{l,n+d-l}-B_{j,n+d-l}, so that said second intermediate matrix value Xₜₑₘₚ is non-invertible;
(c) Sequentially apply said first modulus operators m_{l,1}-m_{i,1} to said non-invertible second intermediate matrix value Xₜₑₘₚ to generate output value of non-invertible pseudo-random number matrix Xₙ from which at least one pseudo-random number is extracted; and
(d) Select a subset of pseudo-random number output values from said non-invertible pseudo-random number matrices

14. An apparatus for generating a pseudo-random number, said apparatus comprising:
(a) Output matrices initialization means for establishing initialization values for output series of pseudo-random number matrices Xₗ-Xₖ;
(b) Transition matrices initialization means for establishing initialization values for variable transition matrices A_{l,1}-A_{k,1};
(c) Offset matrices initialization means for establishing initialization values for variable offset matrices B_{l,1}-B_{j,1};
(d) Modulus operator means for establishing first modulus operators m_{l,1}-m_{i,1};
(e) First application means for applying said transition matrices A_{l,1}-A_{k,1} to said output series of pseudo-random number matrices Xₗ-Xₖ to generate a first intermediate matrix value X_{firsttemp};
(f) Second application means for applying said offset matrices B_{l,1}-B_{j,1} to said first intermediate matrix value X_{firsttemp} to generate a second intermediate matrix value Xₜₑₘₚ; and
(g) Third application means for sequentially applying said first modulus operators m_{l,1}-m_{i,1} to said second intermediate matrix value Xₜₑₘₚ to generate an output value of pseudo-random number matrix Xₙ from which at least one pseudo-random number is extracted.

15. An apparatus for generating a plurality of pseudo-random numbers, said apparatus comprising:
(a) Output matrices initialization means for establishing initialization values for output series of pseudo-random number matrices Xₗ-Xₖ;
(b) Transition matrices initialization means for establishing initialization values for variable transition matrices A_{l,1}-A_{k,1};
(c) Offset matrices initialization means for establishing initialization values for variable offset matrices B_{l,1}-B_{j,1};
(d) Modulus operator means for establishing first modulus operators m_{l,1}-m_{i,1};
(f) First application means for applying said transition matrices A_{l,1}-A_{k,1} to said output series of pseudo-random number matrices Xₗ-Xₖ to generate a first intermediate matrix value X_{firsttemp};
(g) Second application means for applying said offset matrices B_{l,1}-B_{j,1} to said first intermediate matrix value X_{firsttemp} to generate a second intermediate matrix value Xₜₑₘₚ;
(h) Third application means for sequentially applying said first modulus operators m_{l,1}-m_{i,1} to said second intermediate matrix value Xₜₑₘₚ to generate a first output value of pseudo-random number matrix Xₙ from which at least one pseudo-random number is extracted;
(i) Storage means for storing said first output value matrix Xₙ in a storage register to establish an updated output series of pseudo-random number matrices;
(j) Transition matrices updating means for updating said transition matrices A_{l,1}-A_{k,1} to create updated transition matrices A_{l,2}-A_{k,2};
(k) Fourth application means for applying said updated transition matrices A_{l,2}-A_{k,2} to said updated output series of pseudo-random number matrices X_{n-k+l-X}ₙ to generate an updated first intermediate matrix value X_{firsttemp};
(l) Offset matrices updating means for updating said offset matrices B_{l,1}-B_{j,1} to create updated offset matrices B_{l,2}-B_{j,2};
(m) Fifth application means for applying said updated offset matrices B_{l,2}-B_{j,2} to said updated first intermediate matrix value X_{firsttemp} to generate an updated second intermediate matrix value Xₜₑₘₚ;
(n) Modulus operator updating means for updating said first modulus operators m_{l,1}-m_{i,1} to create updated first modulus operators m_{l,2}-m_{i,2};
(o) Sixth application means for sequentially applying said updated first modulus operators m_{l,2}-m_{i,2} to said updated second intermediate matrix value Xₜₑₘₚ to generate a second output value of pseudo-random number matrix Xₙ₊ₗ from which at least one pseudo-random number is extracted; and
(p) Second storage means for storing said second pseudo-random number matrix Xₙ₊ₗ in said storage register of pseudo-random number matrices.
